(19) United States
(12) Patent Application Publication
(10) Pub. No.: US 2016/0215814 A1
(43) Pub. Date: Jul. 28, 2016

(54) HOUSING OF A BALL JOINT ASSEMBLY

(71) Applicant: Caterpillar Inc., Peoria, IL (US)

(72) Inventors: David L. Cox, Monticello, IL (US); Nathaniel Keith Harshman, Sullivan, IL (US)

(73) Assignee: Caterpillar Inc., Peoria, IL (US)

(21) Appl. No.: 15/092,322

(22) Filed: Apr. 6, 2016

(51) Int. Cl. F16C 11/06

(52) U.S. Cl. CPC F16C 11/0628; F16C 11/068

(57) ABSTRACT

An assembly for a ball joint is provided. The assembly includes a housing assembly having a first section and a second section. Each of the first and second sections includes a concave spherical portion having a channel and an aperture. Each of the first and second sections includes a flange extending outwardly from sides of the concave spherical portion. The flange includes an aperture for receiving a fastener. The concave spherical portion of the first and second sections defines a ball seat. The apertures defined in the flange are axially aligned to connect the first and second sections through the fastener. The assembly includes an insert having a partial hemispherical shape configured to rest in the concave spherical portion. The insert includes a protrusion configured to mate with the channel. The insert includes a groove having an aperture axially aligned with the aperture in the channel to receive a lubricant.

### TECHNICAL FIELD

The present disclosure relates to a ball joint assembly. More particularly, the present disclosure relates to a housing of the ball joint assembly.

### BACKGROUND

A motor grader is a construction machine with a long blade used to create a flat surface during the grading process. The motor grader has a longitudinal main frame which has a steerable wheel assembly at a front end thereof, an operator cab at a rear end of the machine, and a traction chassis for a motor and a power train behind the cab. A motor grader blade is suspended from the main frame by means of a circle drawbar and a circle. The circle drawbar has a front end connected to the front of the main frame by a ball and socket connection, while the rearward portion of the circle drawbar is suspended from the main frame by hydraulic cylinders and piston means which permit the draw bar to swing either in a vertical plane or a horizontal plane about its front end.

Typically, the motor grader has three hydraulic cylinders for positioning the blade. The hydraulic cylinders transfer force to the blade through ball joints on the drawbar fastened through a mechanical fastener, such as bolts. A ball joint typically comprises of a spherical ball rotatably coupled to a ball seat. The ball seat may have a two-part design joined to each other by a bolted connection. The ball and the ball seat are connected to different components, hence transferring force therebetween, However, over time, the ball joint may get worn or damaged. Replacement of the ball joint may be an expensive as well as time consuming process.

Accordingly, inserts may be provided between the ball and the ball seat. The inserts are retained with the help of tabs with holes. Bolts used for fastening the two parts of the ball seat pass through the holes in the tabs to keep the inserts in place. Additionally, shims may be used between the inserts to finely adjust slop or play in the ball joint. As the ball joint and wear inserts are manufactured separately, geometry of the insert may not perfectly match the geometry of the ball joint. To adjust the differences in geometry, additional shims are required on the outside of the insert. This creates problems during service of the ball joint assembly as shims are used for two different purposes of accounting for slop as well as manufacturing tolerances in the ball joint and may get erratically replaced. Further, as the ball joint encounters high levels of stress, lubrication of the ball joint is an important aspect for efficient functioning of the ball joint. Lubrication is provided through a lubrication hole in the ball seat supplying lubricant, such as grease through the hole. However, as the lubricants typically have high viscosity, some portions of the ball joint assembly may not get lubricated at all, leading to increased wear.

U.S. Pat. No. 8,061,921 describes a ball joint assembly having an insert made of synthetic resin molded in the ball seat. The insert, which is an integral part of the ball seat, is provided with grease grooves which are tilled with lubricant beforehand and are sealed by the ball housed in the ball seat. The grease grooves provide for adequate lubrication of the ball joint. Eventually, the insert gets worn and needs to be replaced, However, the insert being molded with the ball seat may not be easily replaced.

Replacing the ball joint assembly altogether is an expensive as well as time consuming process. It may cause significant downtime which may further effect productivity of the motor grader. Hence, there is a need for an improved ball joint assembly design.

### SUMMARY OF THE DISCLOSURE

In an aspect of the present disclosure, an assembly for a ball joint for articulating a blade of a motor grader is provided. The assembly includes a housing assembly having a first section and a second section. Each of the first section and the second section includes a concave spherical portion having a channel defined along an inner surface thereof. Each of the first section and the second section includes an aperture defined in the channel. Each of the first section and the second section includes a flange extending outwardly on both sides of the concave spherical portion in a transverse direction. The flange includes an aperture for receiving a fastener therethrough. The concave spherical portion of the first section and the second section respectively defines a ball seat. The aperture defined in the flange of the first section and the second section respectively is configured to be axially aligned to connect the first section and the second section through the fasteners. The assembly includes an insert having a partial hemispherical shape configured to rest in the concave spherical portion. The insert includes a protrusion defined along an outer surface thereof. The protrusion is configured to mate with the channel defined in the concave spherical portion, The insert includes a groove defined on an inner surface having an aperture configured to be axially aligned with the aperture in the channel to receive a lubricant therethrough.

Other features and aspects of this disclosure will be apparent from the following description and the accompanying drawings.

### BRIEF DESCRIPTION OF THE DRAWINGS

FIG. 1 is a side view of an exemplary machine, according to one embodiment of the present disclosure;

FIG. 2 is a perspective exploded view of a ball joint assembly of the machine of FIG. 1, according to one embodiment of the present disclosure;

FIG. 3 is a perspective view of one section of a housing assembly of the ball joint assembly, according to one embodiment of the present disclosure; and

FIG. 4 is a perspective view of an insert and the one section of the housing assembly of the ball joint assembly of FIG. 3, according to one embodiment of the present disclosure.

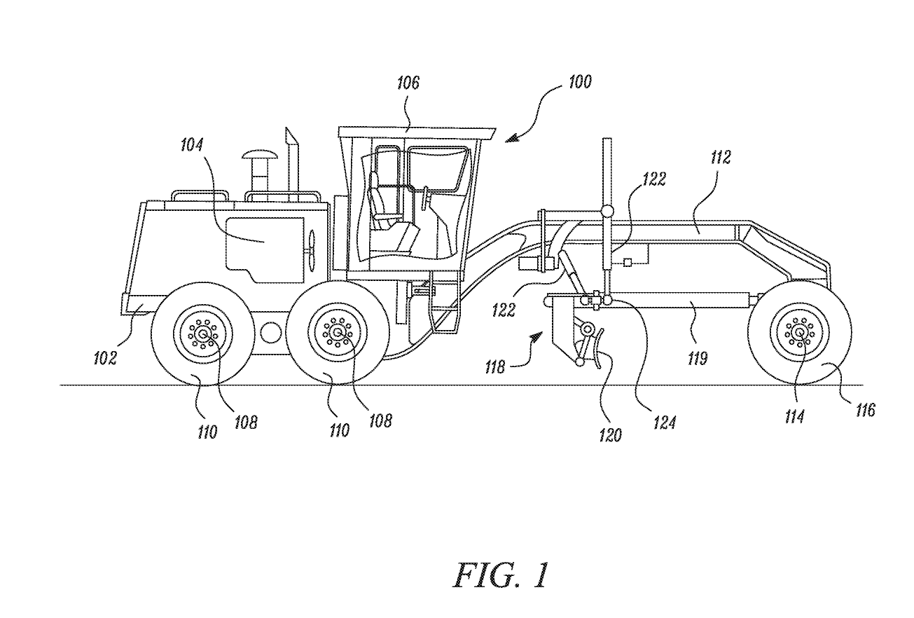

### DETAILED DESCRIPTION

Wherever possible, the same reference numbers will be used throughout the drawings to refer to the same or the like parts. Referring to FIG. 1, an exemplary machine 100 is illustrated. More specifically, the machine 100 is a motor grader. The machine 100 is configured to flatten uneven ground surface such as during grading process prior to road construction, moving of snow, debris, and so on.

The machine 100 includes a main frame 102. The main frame 102 is configured to support various components of the machine 100 such as an engine 104, an operator cabin 106, one or more rear axles 108, rear wheels 110, and on on. The machine 100 also includes a front frame 112 coupled to the main frame 102. The front frame 112 is configured to support a steerable front axle 114. The front axle 114 is configured to support front wheels 116 and provide steering to the machine 100 on the ground. The front frame 112 is also configured to support a blade assembly 118 of the machine 100.

More specifically, the blade assembly 118 is supported by using a drawbar 119 and a circle (not shown) coupled to the front frame 112. The blade assembly 118 includes a blade 120. The blade assembly 118 also includes one or more hydraulic cylinders 122 to support the blade 120. One end of the hydraulic cylinders 122 is coupled to the front frame 112. Another end of the hydraulic cylinders 122 is coupled to the blade 120 using a ball joint assembly 124. The ball joint assembly 124 is configured to articulate the blade 120 of the machine 100.

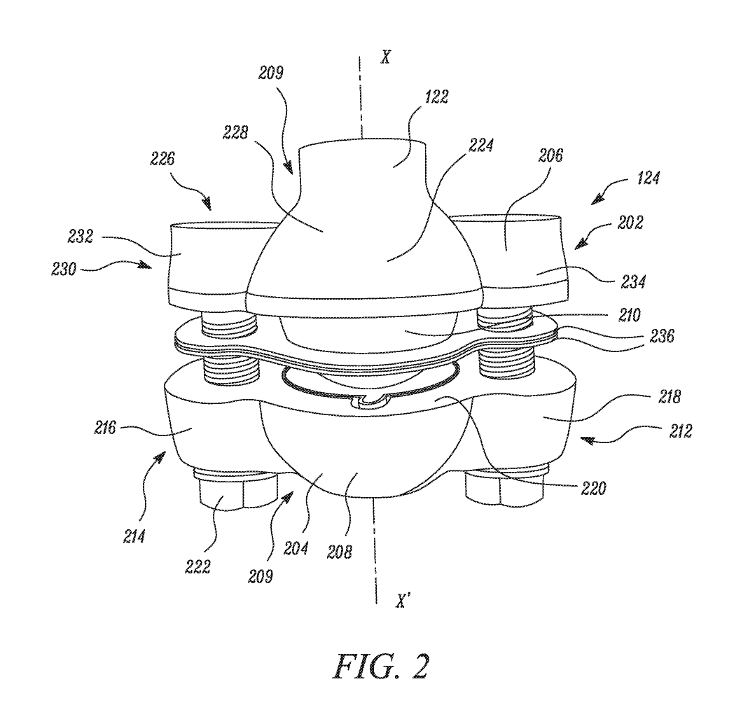

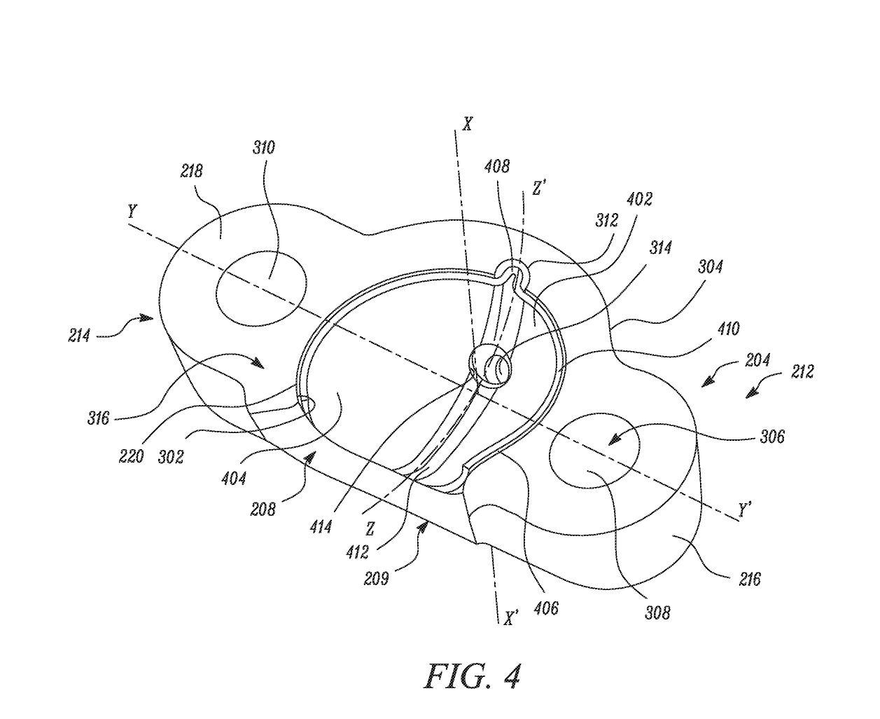

Referring to FIGS. 2 to 4, the ball joint assembly 124 includes a housing assembly 202 defining a central axis X-X′, More specifically, the housing assembly 202 includes a first section 204 and a second section 206. The first section 204 may be made of any metal known in the art such as steel, and so on. The first section 204 includes a first concave spherical portion 208, The first concave spherical portion 208 includes a first inner surface 302 and a first outer surface 304. The first concave spherical portion 208 defines a ball seat 209 configured to receive a ball 210 of the ball joint assembly 124. More specifically, the first inner surface 302 defines a first half 212 of the ball seat 209 and is configured to receive the ball 210 of the ball joint assembly 124. The ball 210 is further coupled to the blade 120 (see FIG. 1) using any known mechanical coupling, method such as welding, bolting, and so on.

The first section 204 includes a first flange 214 extending outwardly from both sides of the first concave spherical portion 208. More specifically, the first flange 214 includes a first flange member 216 and a second flange member 218 extending outwardly from an edge 220 of the first concave spherical portion 208. Additionally, the first flange member 216 and the second flange member 218 extend away from the central axis X-X′ and along a transverse axis Y-Y′ opposite one another.

Each of the first flange member 216 and the second flange member 218 includes an aperture 306. More specifically, the first flange member 216 includes a first aperture 308 and the second flange member 218 includes a second aperture 310. Each of the first aperture 308 and the second aperture 310 is configured to receive a fastener 222 therethrough such as a screw, a stud bolt, a machine bolt, and so on. The fastener is configured to couple the first section 204 to the second section 206 and will be explained later in more detail,

The first concave spherical portion 208 includes a channel 312 having a length “L” defined across the first inner surface 302. More specifically, the first inner surface 302 includes the channel 312 extending along a longitudinal axis Z-Z′. The channel 312 extends from one point on the edge 220 of the first concave spherical portion 208 to another point on the edge 220 of the first concave spherical portion 208. The first concave spherical portion 208 includes one channel 312 provided across the first inner surface 302. In other embodiments, the first concave spherical portion 208 may include multiple channels 312. Each of the multiple channels 312 may have similar or varying dimensions. Also, the multiple channels 312 may be provided in varying configurations such as parallel to one another, intersecting one another, and so on.

Further, the first concave spherical portion 208 includes an aperture 314 defined in the channel 312. More specifically, the aperture 314 is defined across the first inner surface 302 and the first outer surface 304. The aperture 314 includes a circular configuration. In other embodiments, the aperture 314 may include other configurations such as oval, rectangular, triangular, and so on. Also, it is evident that the aperture 314 may be located at any different orientation or position within the inner surface 302. The aperture 314 is configured to receive a lubricant such as oil, grease, and so on therethrough.

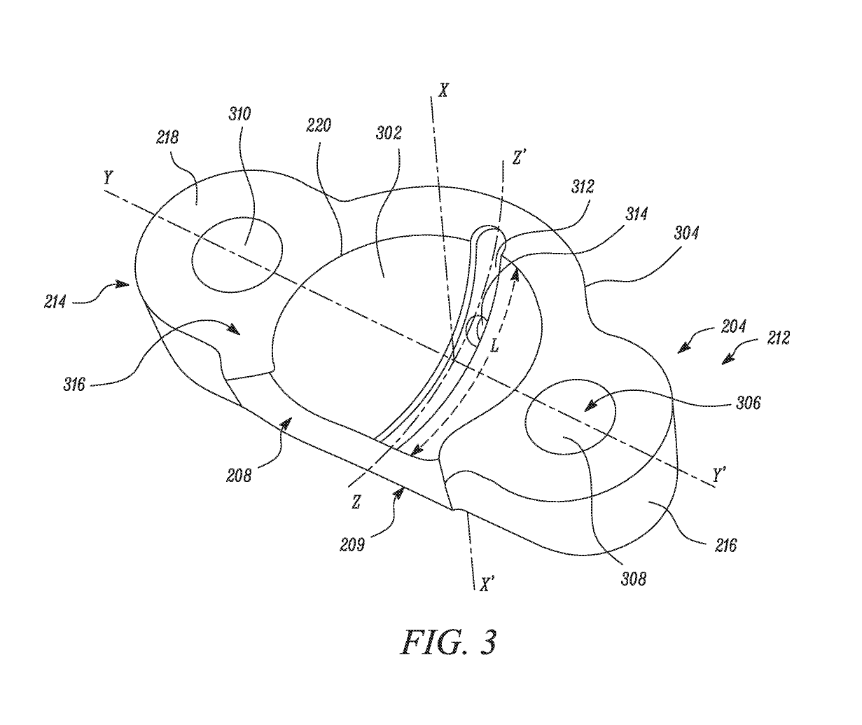

As shown in FIG. 3, the first concave spherical portion 208 includes one aperture 314 provided in the channel 312, In other embodiments, the first concave spherical portion 208 may include multiple apertures 314 provided in the channel 312. Each of the multiple apertures 314 may have similar or varying dimensions and configurations. Also, in the embodiment having multiple channels 312, one or more apertures 314 may be provided in each of the multiple channels 312. It should be noted that the number, location, dimension, and configuration of the channel 312 and/or the aperture 314 may vary based on the application requirements and may not limit the scope of the disclosure.

The ball joint assembly 124 also includes a first insert 402. The first insert 402 may be made of any material known in the art including polymer, metal such as steel, and so on. The first insert 402 includes a partial hemispherical shape defining an inner surface 404 and an outer surface 406. The first insert 402 is configured to rest in the first concave spherical portion 208 in a manner such that the outer surface 406 of the first insert 402 contacts the first inner surface 302 of the first concave spherical portion 208. The inner surface 404 is configured to receive the ball 210 of the ball joint assembly 124. The first insert 402 is configured to provide a wear surface between the first inner surface 302 of the first concave spherical portion 208 and the ball 210. The first insert 402 is also configured to provide a lubrication path between the first concave spherical portion 208 and the ball. 210 and will be explained later in more detail.

The first insert 402 includes a protrusion 408 defined along the outer surface 406 thereof The protrusion 408 is shaped and located on the outer surface 406 in correspondence to the channel 312 on the first inner surface 302 of the first concave spherical portion 208, More specifically, the outer surface 406 includes the protrusion 408 extending along the longitudinal axis Z-Z′. The protrusion 408 extends from one point on an edge 410 of the first insert 402 to another point on the edge 410 of the first insert 402. The protrusion 408 is configured to mate with the channel 312 provided in the first concave spherical portion 208. More specifically, an arrangement of the protrusion 408 within the channel 312 provides correct alignment and retention of the first insert 402 within the first concave spherical portion 208.

The first insert 402 includes one protrusion 408 provided across the outer surface 406. In other embodiments, the first insert 402 may include multiple protrusions 408 corresponding to the multiple channels 312. Each of the multiple protrusions 408 may have similar or varying dimensions and configurations. Also, the multiple protrusions 408 may be provided in varying configurations such as parallel to one another, intersecting one another, and so on.

The first insert 402 includes a groove 412 defined along the inner surface 404 thereof The groove 412 is positioned on the inner surface 404 at a location axially corresponding to that of the protrusion 408 on the outer surface 406 of the first insert 402. More specifically, the inner surface 404 includes the groove 412 extending along the longitudinal axis Z-Z′. The groove 412 extends from one point on the edge 410 of the first insert 402 to another point on the edge 410 of the first insert 402. The groove 412 is configured to provide the lubrication path between the first concave spherical portion 208 and the ball 210.

In the illustrated embodiment, the first insert 402 includes one groove 412 provided across the inner surface 404. In other embodiments, the first insert 402 may include multiple grooves 412 corresponding to the multiple protrusions 408. Each of the multiple grooves 412 may have similar or varying dimensions and configurations. Also, the multiple grooves 412 may be provided in varying configurations such as parallel to one another, intersecting one another, and so on.

Further, the first insert 402 includes an aperture 414 defined in the groove 412. More specifically, the aperture 414 is defined through the inner surface 404 and the outer surface 406 of the first insert 402 in a manner such that the aperture 414 connects the groove 412 and the protrusion 408. Also, the aperture 414 in the groove 412 is axially aligned with the aperture 314 in the channel 312 of the first concave spherical portion 208. The aperture 414 has a circular configuration. In other embodiments, the aperture 414 may have other configurations such as oval, rectangular, triangular, and so no The aperture 414 is configured to receive the lubricant from the aperture 314 in the channel 312 and further into the groove 412.

The first insert 402 includes one aperture 414 provided in the groove 412. In other embodiments, the first insert 402 may include multiple apertures 414 provided in the groove 412. Each of the multiple apertures 414 may have similar or varying dimensions and configurations, Also, in the embodiment having multiple grooves 412, one or more apertures 414 may be provided in each of the multiple grooves 412. It should be noted that the number, location, dimension, and configuration of the groove 412 and/or the aperture 414 may vary based on the application requirements and may not limit the scope of the present disclosure.

The housing assembly 202 further includes the second section 206 having a configuration similar to that of the first section 204. The second section 206 may be made of any metal known in the art such as steel, and no on. More specifically, the second section 206 includes a second concave spherical portion 224 having a configuration similar to that of the first concave spherical portion 208. The second concave spherical portion 224 includes a second inner surface (not shown) having a configuration similar to that of the first inner surface 302 of the first concave spherical portion 208, More specifically, the second inner surface defines a second half 226 of the ball seat 209 and is configured to receive the ball 210 of the ball joint assembly 124.

The second concave spherical portion 224 includes a second outer surface 228 having a configuration similar to that of the first outer surface 304 of the first concave spherical portion 208. The second outer surface 228 is configured to be attached to another end of the hydraulic cylinders 122 by any known coupling method such as, for example, welding. In some embodiments, the other end of the hydraulic cylinders 122 may be integrally cast with the second concave spherical portion 224.

The second section 206 includes a second flange 230 having a configuration similar to that of the first flange 14 of the first section 204. More specifically, the second section 206 includes a third flange member 232 and a fourth flange member 234 having a configuration similar to that of the first flange member 216 and the second flange member 218 of the first concave spherical portion 208 respectively. Further, the third flange member 232 includes a third aperture (not shown) having a configuration similar to the first aperture 308. The fourth flange member 234 includes a fourth aperture (not shown) having a configuration similar to the second aperture 310. During assembly, the third aperture and the fourth aperture are axially aligned with the first aperture 308 and the second aperture 310 respectively to receive the fastener 222 therethrough and couple the first section 204 and the second section 206 with each other.

The second concave spherical portion 224 may include a channel (not shown) and an aperture (not shown) defined thereon having a configuration similar to that of the channel 312 and the aperture 314 of the first concave spherical portion 208 respectively. The ball joint assembly 124 may also include a second insert (not shown) having a configuration similar to the first insert 402. The second insert may be made of any material known in the art including polymer, metal such as steel, and so on. More specifically, the second insert may include a protrusion, a groove, and an aperture having a configuration similar to the protrusion 408, the groove 412, and the aperture 414 of the first insert 402.

Referring to FIG. 2, the ball joint assembly 124 includes one or more shims 236 provided between the first section 204 and the second section 206 of the ball joint assembly 124. The shim 236 is configured to compensate for wear and clearance between the first section 204 and the second section 206 during assembly. The shim 236 includes a thin, plate-like configuration. Also, a shape of the shim 236 is substantially similar to a shape of a face 316 of the first concave spherical portion 208 and/or the second concave spherical portion 224. More specifically, the shim 236 includes a central aperture (not shown) to receive the ball 210, and a pair of side apertures (not shown) provided on opposite sides of the central aperture, Each of the pair of side apertures is configured to receive the fastener 222 therethrough. The shim 236 may be made of any metal known in the art such as steel, and so on.

### INDUSTRIAL APPLICABILITY

The present disclosure relates to the housing assembly 202 of the ball joint assembly 124, The first insert 402 of the ball joint assembly 124 provides a wear surface between the first concave spherical portion 208 and the ball 210 of the ball joint assembly 124. The second insert (not shown) of the ball joint assembly 124 provides a wear surface between the second concave spherical portion 224 and the ball 210 of the ball joint assembly 124. The arrangement of the protrusion 408 of the first insert 402 and the channel 312 of the first section 204, and the protrusion of the second insert and the channel of the second section 206, are designed to provide correct alignment and retention of the first insert 402 and the second insert in the first concave spherical portion 208 and the second concave spherical portion 224 respectively. The geometry and the arrangement of the protrusion 408 and the channel 312, and also the overall shape of the first insert 402 and the second insert is such that the first insert 402 and the second insert are self-retained within the first section 204 and the second section 206 respectively.

Additionally, the placement of the channel 312 and the aperture 314 on the first section 204 and the second section 206, and the placement of the protrusion 408, the groove 412 and the aperture 414 on the first insert 402 and the second insert is such that an interconnected lubricant path is formed within the ball joint assembly 124, for receiving and spreading the lubricant at an interface of the first insert 402 and the second insert of the ball joint assembly 124 and the ball 210. This assists in improving component life of the ball joint assembly 124.

Due to the overall geometry of the first insert 402 and/or the second insert, the manufacturing tolerances, generally present in the ball joint assembly 124 assembled without the first insert 402 and/or the second insert, may be reduced. As such, the shims 236 may now be provided between the first section 204 and the second section 206 to only account for wear of the ball joint assembly 124. During operation, as the first insert 402 and/or the second insert may wear out, individual shims 236 may be removed for accounting for the wear and compensating for the new tolerance thus created. This may reduce the complexity associated with the use of shims 236 compared to situations when the shims 236 may be used to account for both the wear as well as the manufacturing tolerances.

Further, after prolonged use and/or considerable wear, the first insert 402 and/or the second insert may be replaced with a new set of the first insert 402 and/or the second insert respectively in place of replacing the complete ball joint assembly 124. This may reduce considerable machine downtime and maintenance/replacement cost.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of the disclosure. Such embodiments should be understood to fall within the scope of the present disclosure as determined based upon the claims and any equivalents thereof.

What is claimed is:

1. An assembly for a ball joint for articulating a blade of a motor grader, the assembly comprising:
a housing assembly having a first section and a second section, wherein each of the first section and the second section includes:
a concave spherical portion having a channel defined along an inner surface thereof and an aperture defined in the channel; and
a flange extending outwardly on both sides of the concave spherical portion in a transverse direction, wherein the flange includes an aperture for receiving a fastener therethrough;
wherein the concave spherical portion of the first section and the second section respectively defines a ball seat, and the aperture defined in the flange of the first section and the second section respectively are configured to be axially aligned to connect the first section and the second section through the fastener; and
an insert having a partial hemispherical shape configured to rest in the concave spherical portion, wherein the insert includes a protrusion defined along an outer surface thereof, the protrusion configured to mate with the channel defined in the concave spherical portion, and wherein the insert includes a groove defined on an inner surface having an aperture configured to be axially aligned with the aperture in the channel to receive a lubricant therethrough.

2. The assembly of claim 1 further including one or more shims located between the first section and the second section.
